(19) United States
(12) Patent Application Publication
(10) Pub. No.: US 2013/0022739 A1
(43) Pub. Date: Jan. 24, 2013

(54) METHOD OF DIP-COATING A LENS

(71) Applicants: John Biteau, St. Petersburg, FL (US); Christy Ford, St. Petersburg, FL (US); Arnaud Glacet, St. Petersburg, FL (US)

(72) Inventors: John Biteau, St. Petersburg, FL (US); Christy Ford, St. Petersburg, FL (US); Arnaud Glacet, St. Petersburg, FL (US)

(73) Assignee: ESSILOR INTERNATIONAL (COMPAGNIE GENERALE D' OPTIQUE), Charentio Le Pont (FR)

(21) Appl. No.: 13/637,671

(22) PCT Filed: Apr. 2, 2010
(86) PCT No.: PCT/US10/29754

§ 371 Date: Sep. 27, 2012

(51) Int. Cl. B05D 1/18

(52) U.S. Cl. 427/162

(57) ABSTRACT

A method of dip-coating a lens includes the steps of: immersing the lens (10) in a coating solution bath (2) having a horizontal coating solution surface (4), and withdrawing the lens (10) from the bath (2) through the solution surface (4). The step of withdrawing is performed with a movement of the lens such that the orientation of the lens (10) varies continuously, from a position in which the optical axis (A) of the lens (10) is inclined upwards and towards the concave surface (12) of the lens (10) when the lens (10) starts emerging from the bath (2) to a position in which the optical axis (A) of the lens (10) is inclined upwards and towards the convex surface (11) of the lens (10) when the lens (10) finishes emerging from the bath (2).

### FIELD OF THE INVENTION

The invention relates to the dip-coating of a lens such as an ophthalmic lens.

### BACKGROUND ART

One known method for coating the surfaces of a lens, for instance with an anti-reflective coating, is dip-coating.

In dip-coating, the lens is immersed in a coating solution bath and then withdrawn from the bath.

Dip-coating is very convenient but there is often a thickness variation of the coating between the top and the bottom of the lens, that is between the portions of the lens emerging respectively first and last.

Such a thickness variation is explained by the Landau & Levich theory which shows that for a lens having a convex surface and a concave surface, the coating is thicker at the top of the convex surface than at the bottom and thinner at the top of the concave surface than at the bottom.

Another reason for the thickness variation is the drainage of the liquid coating on the surfaces of the lens during and after the withdrawing step.

The invention is directed to a method of dip-coating which limits thickness variations.

### SUMMARY OF THE INVENTION

The invention accordingly provides a method of dip-coating a lens having a convex surface and a concave surface to be dip-coated, the method comprising the steps of:

immersing the lens in a coating solution bath having a horizontal coating solution surface, and

withdrawing the lens from said bath through said solution surface,

wherein the step of withdrawing is performed with a movement of the lens such that the orientation of the lens varies continuously, from a position in which the optical axis of the lens is inclined upwards and towards the concave surface of said lens when said lens starts emerging from said bath to a position in which the optical axis of the lens is inclined upwards and towards the convex surface of said lens when said lens finishes emerging from said bath.

The invention is based on the observation that with the conventional vertical withdrawal movement of the lens, that is with the optical axis of the lens remaining horizontal, at each moment during the withdrawal movement, at the line of contact with the horizontal coating solution surface, the concave surface and the convex surface have local orientations (on the line of contact) which are very different.

With the continuous variation of the orientation of the lens according to the invention, the concave surface passes through the horizontal coating solution surface with a local orientation which remains close to the local orientation of the convex surface.

Thanks to the closeness of the local orientations, the difference of thicknesses of the coatings on the concave and on the convex surfaces is minimized.

It should be noted that it is already known from U.S. Pat. No. 5,153,027 to vary the orientation of a windshield when the windshield is withdrawn from the bath, the withdrawal movement being such that the orientation of the windshield remains perpendicular to a pivot. The goal of the variation of orientation is to achieve a thickness gradient on the windshield surfaces.

This is totally different from the method according to the invention, inter alia because:

a windshield is not a lens having an optical axis;

even if the central axis of the windshield is taken into account, U.S. Pat. No. 5,153,027 teaches to maintain the central axis parallel to a pivot, i.e. to maintain the central axis parallel to itself, which is the contrary of the method of the invention where the optical axis has a continuously varying inclination; and

achieving a thickness gradient is exactly the opposite of limiting the thickness variations as in the method of the invention.

According to preferred features of the method of the invention, said movement is performed such that the angles that the horizontal coating solution surface makes with the convex and concave surfaces are substantially equal during the withdrawal movement.

Of course, the angles are measured between the horizontal coating solution surface and the tangent to the convex surface or the concave surface at the line of contact with the horizontal coating solution surface in the vertical plane containing the optical axis.

Maintaining the equality or substantial equality of the angles on the convex surface side and on the concave surface side is very favourable to obtaining the same thickness on both sides.

According to features preferred as being very simple, convenient and economical for embodying the method according to the invention, the withdrawal movement is made with a fixed center of rotation positioned in the plane of said horizontal coating solution surface.

According to further preferred features:

said center of rotation is the center of a circle arc reference line intermediate said convex and concave surfaces of the lens and crossing the optical axis of the lens;

said circle arc reference line has a radius determined by the following equation:

$${R}_{reference} = \frac{{R}_{cx} + {R}_{cc}}{2} ;$$

wherein:

R_{reference} is the radius of the reference line;

R_{cx} is a radius of curvature of said convex surface; and

R_{cc} is a radius of curvature of said concave surface;

said convex and concave surfaces are spherical, and R_{cx} is the radius of said convex surface and R_{cc} is the radius of said concave surface;

said lens has a toric axis, the circle arc reference line is in a plane containing the toric axis of said lens, each of said convex and concave surfaces has a spherical component, and Rcx is the radius of the spherical component of said convex surface and Rcc is the radius of the spherical component of said concave surface;

said circle arc reference line has a radius determined by the following equation:

$${R}_{reference} = \frac{2 \times {R}_{cx} \times {R}_{cc} + \frac{{T}_{c}}{2} \times ( {R}_{cx} - {R}_{cc} )}{( {R}_{cx} + {R}_{cc} )} ;$$

wherein:

R_{reference} is the radius of the reference line;

R_{cx} is a radius of curvature of said convex surface; and

R_{cc} is a radius of curvature of said concave surface;

T_{c} is a central thickness of said lens;

said convex and concave surfaces are spherical, and R_{cx} is the radius of said convex surface and R_{cc} is the radius of said concave surface, and T_{c} is measured on the optical axis of lens; and/or

said lens has a toric axis, the circle arc reference line is in a plane containing the toric axis of said lens, each of said convex and concave surfaces has a spherical component, R_{cx} is the radius of the spherical component of said convex surface and R_{cc} is the radius of the spherical component of said concave surface, and T_{c} is measured on the optical axis of the lens.

According other preferred features of the invention, useful in particular when the convex surface and/or the concave surface are of complex shape, for instance for a lens which is a progressive spectacle lens, the withdrawal movement is made with a mobile center of rotation remaining in the plane of said horizontal coating solution surface.

According to other preferred features, the withdrawal movement is performed with a variation of withdrawal speed.

As mentioned above, the thickness variations in the conventional dip-coating method are caused not only by the curvature of the concave surface and the convex surface (first reason) but also by the drainage of the liquid coating on the surfaces during and after the withdrawing step (second reason).

The variation of orientation of the lens during withdrawal obviates the first reason and the variation of withdrawal speed obviates the second reason.

It should be noted that varying simultaneously the orientation of the lens and the withdrawal speed enables to obviate simultaneously both reasons and therefore provide excellent result.

According to other preferred features:

the withdrawal speed is decreased between the time when said lens starts emerging from said bath and the time when said lens finishes emerging from said bath; and/or

the lens is a spectacle lens.

### BRIEF DESCRIPTION OF THE DRAWINGS

The description of the invention continues now with a detailed description of a preferred embodiment given hereinafter by way of nonlimiting illustration and with reference to the appended drawings. In these drawings:

FIGS. 1 to 5 are schematic sectional views of a first lens being withdrawn from a coating bath at different stages of the withdrawing step;

FIGS. 6 to 10 are schematic sectional views of a second lens being withdrawn from a coating bath at different stages of the withdrawing step;

FIG. 11 shows a spectacle lens having a toric axis; and

FIG. 12 is a partial schematic view showing an embodiment where the center of rotation is mobile.

### DETAILED DESCRIPTION OF PREFERRED EMBODIMENTS

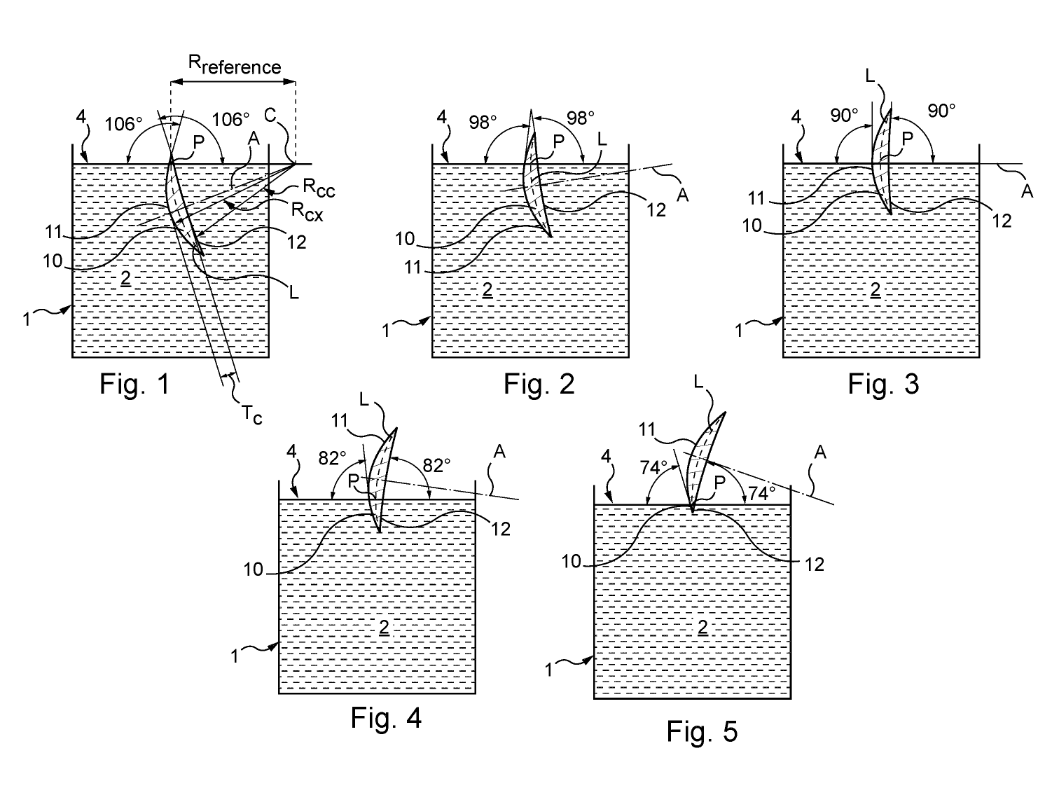

FIGS. 1 to 5 show a bath 1 of a coating solution 2 in which a lens 10 has been fully immersed and is being withdrawn.

The coating solution 2 is for example an anti-reflective coating solution.

The bath 1 has a horizontal coating solution surface 4 through which the lens 10 is withdrawn.

The lens is a spectacle lens 10 having an optical axis A.

Here, lens 10 has a cylindrical power equal to +8 diopters.

The lens 10 has a convex surface 11 and a concave surface 12, which are optical grade surfaces. The convex and concave surfaces 11 and 12 are spherical and coaxial.

The radius of the spherical concave surface R_{cc} is approximately equal to 546 mm, and the radius of the spherical convex surface R_{cx} is approximately equal to 43 mm.

The lens 10 has a central thickness T_{c} measured on the optical axis A of the lens 10, which is approximately equal to 9 mm.

As is apparent in FIGS. 1 to 5, the lens 10 is withdrawn through the horizontal coating solution surface 4 in an arcuate (curved) movement.

The arcuate movement is performed with a multi-axis machine, for example a robot (not shown) having an arm carrying at its distal end a holder having for example three fingers, one of which being mobile, in order to take the lens 10.

The machine is adapted to operate at low angular speeds.

The arcuate movement is made with a fixed center of rotation C which is positioned in the plane of the horizontal coating solution surface 4.

Here, the center of rotation C is the center of a circle arc reference line L intermediate the convex and concave surfaces 11 and 12 of the lens 10 and crossing the optical axis A of the lens 10.

Since C is at a fixed location in the plane of the horizontal coating solution surface 4, circle arc reference line L continuously crosses the same point P on the horizontal coating solution surface 4 during withdrawal movement.

The circle arc reference line L has a radius R_{reference} based on the radii R_{cx} and R_{cc} of the spherical convex and concave surfaces 11 and 12 of the lens 10.

The radius R_{reference} is determined by the following equation:

$${R}_{reference} = \frac{2 \times {R}_{cx} \times {R}_{cc} + \frac{{T}_{c}}{2} \times ( {R}_{cx} - {R}_{cc} )}{( {R}_{cx} + {R}_{cc} )} ;$$

wherein:

R_{cx} is the radius of the convex surface 11;

R_{cc} is the radius of the concave surface 12; and

T_{c} is the central thickness of the lens 10.

The radius R_{reference} in this case is thus approximately equal to 76 mm.

The step of withdrawing is performed with the arcuate movement of the lens 10 such that the orientation of the lens 10 varies continuously, as illustrated on FIGS. 1 to 5 which show how lens 10 is oriented from the moment when it starts emerging (FIG. 1) to the moment when it finishes emerging (FIG. 5).

As is apparent in FIG. 1, when lens 10 starts emerging from bath 2, optical axis A is inclined upwards and towards the concave surface 12. In other words, optical axis A is inclined downwards and towards the convex surface 11.

FIG. 2 shows lens 10 with optical axis A in near horizontal orientation, and slightly inclined upwards and towards the concave surface 12.

FIG. 3 shows lens 10 with optical axis A in horizontal orientation.

FIG. 4 shows lens 10 with optical axis A in near horizontal orientation, and slightly inclined upwards and towards the convex surface 11.

And FIG. 5 shows lens 10 with optical axis A inclined upwards and towards the convex surface 11. In other words, the optical axis A of the lens 10 is inclined downwards and towards the concave surface 12.

In FIG. 5, the lens 10 is practically completely withdrawn from the bath 2.

As is apparent in FIGS. 1 to 5, the arcuate movement is performed such that the angles that the horizontal coating solution surface 4 makes with the convex and concave surfaces 11 and 12 are substantially equal during withdrawal.

As mentioned above, the angles taken into account are the angles between the horizontal coating solution surface 4 and the tangent to the convex surface 11 or the concave surface 12 at the line of contact with surface 4 in the vertical plane containing the optical axis A.

FIGS. 1 to 5 show the angle that the horizontal coating solution surface 4 makes with the convex and concave surfaces 11 and 12, said angle being respectively approximately equal to 106°, 98°, 90°, 82° and 74°.

As mentioned above, the arcuate movement is performed such that the fixed point P on the horizontal coating solution surface 4 is continuously coincident with the circle arc reference line L.

The point P remains at the same distance of the center of rotation C during withdrawal movement, as any point of the lens 10.

Moreover, the arcuate movement is performed by the machine such that the lens 10 is withdrawn through the horizontal coating solution surface 4 with a predetermined variation of withdrawal speed.

The speed (and more precisely the speed in the direction of movement) is for example decreased by 20% between the time when the top of lens 10 emerges through surface 4 and the time when the bottom of lens 10 emerges through surface 4.

The appropriate speed variation is found for instance by a series of trials.

Thereby, the combination of the arcuate movement and the variation of withdrawal speed in order to have the appropriate coating solution thickness provide a lens with both the convex surface 11 and concave surface 12 which have a substantially uniform coating thickness profile after withdrawal.

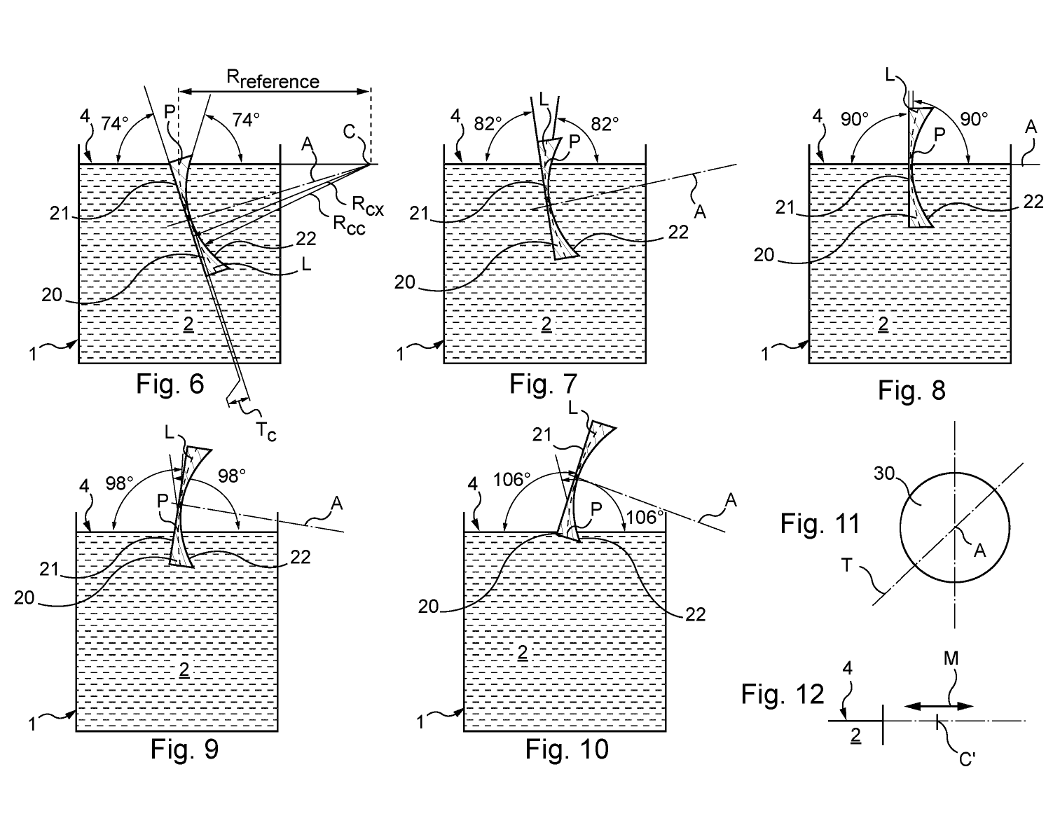

FIGS. 6 to 10 are similar to FIGS. 1 to 5, respectively, except that the lens 20 has different radii of curvature.

The lens is a spectacle lens 20 which has a cylindrical power equal to −10 diopters.

The lens 20 has spherical and coaxial convex and concave surfaces 21 and 22, of which the respective radii R_{cc} and R_{cx} are approximately equal to 47 mm and to 669 mm.

Moreover, the lens 20 has a central thickness T_{c} measured on the optical axis A of the lens 20 approximately equal to 2 mm.

The intermediate circle arc reference line L has a radius R_{reference} determined as previously explained and approximately equal to 89 mm.

FIGS. 6 to 10 show the angle that the horizontal coating solution surface 4 makes with the convex and concave surfaces 21 and 22, said angle being respectively approximately equal to 74° , 82° , 90° , 98° and 106°.

In another embodiment of the present invention, the circle arc reference line L has a radius determined by the following equation:

$${R}_{reference} = \frac{{R}_{cx} + {R}_{cc}}{2} ;$$

wherein:

R_{reference} is the radius of the reference line L;

R_{cx} is a radius of curvature of said convex surface; and

R_{cc} is a radius of curvature of said concave surface.

If the convex and concave surfaces are spherical, R_{cx} is the radius of said convex surface and R_{cc} is the radius of said concave surface.

FIG. 11 shows a spectacle lens 30 having a toric axis T.

Lens 30 is dip-coated like lenses 10 and 20 with the circle arc reference line in a plane containing toric axis T.

The convex and concave surfaces of lens 30 have a spherical component.

The above formulae are applicable with R_{cx} being the radius of the spherical component of the concave surface and R_{cc} being the radius of the spherical component of the concave surface.

FIG. 12 shows another embodiment where the center of rotation C′ of the lens during the withdrawal movement is also in the plane of the horizontal coating surface 4 but the center of rotation C′ is mobile during withdrawal (and not fixed) as shown by arrow M.

This embodiment is useful for lenses having complex surfaces, for instance a progressive spectacle lens.

For moving the lens with a mobile center of rotation such as C′, the above mentioned multi-axes machine (robot arm) is very convenient.

In a variant, for the embodiments where the center of rotation and the radius of rotation are fixed, the machine axis has a simple rigid arm articulated at the center of rotation at one end and carrying the lens at the other end, said simple rigid arm being rotationally driven around the center of rotation.

In each of the above disclosed examples, the lens is a spectacle lens. In other embodiments, the lens is not a spectacle lens, but for instance another ophthalmic lens or a lens for an optical instrument.

Numerous other variants are possible depending on circumstances, and in this regard it is pointed out that the invention is not limited to the examples described and shown.

1. A method of dip-coating a lens (10; 20; 30) having a convex surface (11; 21) and a concave surface (12; 22) to be dip-coated, the method comprising the steps of:
immersing the lens (10; 20; 30) in a coating solution bath (2) having a horizontal coating solution surface (4), and
withdrawing the lens (10; 20; 30) from said bath (2) through said solution surface (4),
wherein the step of withdrawing is performed with a movement of the lens such that the orientation of the lens (10;
20; 30) varies continuously, from a position in which the optical axis (A) of the lens (10; 20; 30) is inclined upwards and towards the concave surface (12; 22) of said lens (10; 20; 30) when said lens (10; 20; 30) starts emerging from said bath (2) to a position in which the optical axis (A) of the lens (10; 20; 30) is inclined upwards and towards the convex surface (11; 21) of said lens (10; 20; 30) when said lens (10; 20; 30) finishes emerging from said bath (2).

2. The method according to claim 1, wherein said movement is performed such that the angles that the horizontal coating solution surface (4) makes with the convex and concave surfaces (11, 12; 21, 22) are substantially equal during the withdrawal movement.

3. The method according to claim 1, wherein said movement is made with a fixed center of rotation (C) positioned in the plane of said horizontal coating solution surface (4).

4. The method according to claim 3, wherein said center of rotation (C) is the center of a circle arc reference line (L) intermediate said convex and concave surfaces (11, 12; 21, 22) of the lens (10; 20; 30) and crossing the optical axis (A) of the lens (10; 20; 30).

5. The method according to claim 4, wherein said circle arc reference line (L) has a radius (R_{reference}) determined by the following equation:
$${R}_{reference} = \frac{{R}_{cx} + {R}_{cc}}{2} ;$$
wherein:
R_{reference} is the radius of the reference line (L);
R_{cx} is a radius of curvature of said convex surface (11; 21); and
R_{cc} is a radius of curvature of said concave surface (12; 22).

6. The method according to claim 5, wherein said convex and concave surfaces (11, 12; 21, 22) are spherical, and wherein R_{cx} is the radius of said convex surface (11; 21) and R_{cc} is the radius of said concave surface (12; 22).

7. The method according to claim 5, wherein said lens (30) has a toric axis (T), wherein the circle arc reference line is in a plane containing the toric axis (T) of said lens (30), wherein each of said convex and concave surfaces has a spherical component, and wherein R_{cx} is the radius of the spherical component of said convex surface and R_{cc} is the radius of the spherical component of said concave surface.

8. The method according to claim 4, wherein said circle arc reference line (L) has a radius (R_{reference}) determined by the following equation:
$${R}_{reference} = \frac{2 \times {R}_{cx} \times {R}_{cc} + \frac{{T}_{c}}{2} \times ( {R}_{cx} - {R}_{cc} )}{( {R}_{cx} + {R}_{cc} )} ;$$
wherein:
R_{reference} is the radius of the reference line (L);
R_{cx} is a radius of curvature of said convex surface (11; 21); and
R_{cc} is a radius of curvature of said concave surface (12; 22).
T_{c} is a central thickness of said lens (10; 20; 30).

9. The method according to claim 8, wherein said convex and concave surfaces (11, 12; 21, 22) are spherical, and wherein R_{cx} is the radius of said convex surface (11; 21) and R_{cc} is the radius of said concave surface (12; 22), and wherein T_{c} is measured on the optical axis (A) of lens (10; 20).

10. The method according to claim 8, wherein said lens (30) has a toric axis (T), wherein the circle arc reference line is in a plane containing the toric axis (T) of said lens (30), wherein each of said convex and concave surfaces has a spherical component, wherein R_{cx} is the radius of the spherical component of said convex surface and R_{cc} is the radius of the spherical component of said concave surface, and wherein T_{c} is measured on the optical axis (A) of the lens (30).

11. The method according to claim 1, wherein said movement is made with a mobile center of rotation (C′) remaining in the plane of said horizontal coating solution surface (4).

12. The method according to claim 1, wherein said movement is performed with a variation of withdrawal speed.

13. The method according to claim 12, wherein the withdrawal speed is decreased between the time when said lens (10; 20; 30) starts emerging from said bath (2) and the time when said lens (10; 20; 30) finishes emerging from said bath (2).

14. The method according to claim 1, wherein the lens (10; 20; 30) is a spectacle lens.

15. The method according to claim 2, wherein said movement is made with a fixed center of rotation (C) positioned in the plane of said horizontal coating solution surface (4).

16. The method according to claim 15, wherein said center of rotation (C) is the center of a circle arc reference line (L) intermediate said convex and concave surfaces (11, 12; 21, 22) of the lens (10; 20; 30) and crossing the optical axis (A) of the lens (10; 20; 30).
